(19) United States
(12) Patent Application Publication
(10) Pub. No.: US 2005/0108303 A1
(43) Pub. Date: May 19, 2005

(54) Remote backup and restore technique

(76) Inventor: Richard D. Carter, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/698,674

(22) Filed: Oct. 31, 2003

(51) Int. Cl. G06F 17/30

(52) U.S. Cl. 707/204

(57) ABSTRACT

In one embodiment, a method for remote data backup and restoration includes creating a signature tag that is associated with a track stored in a memory of a digital entertainment unit, transmitting the signature tag to a repair facility, and authenticating the track based upon the signature tag.

### TECHNICAL FIELD

Embodiments of the invention relate generally to remote backup and restore techniques for various media content such as, for example, music content, video content, image or photography content, or other electronic content.

### BACKGROUND

Various types of home entertainment electronic products are currently available for consumers. These entertainment electronic products can store a large amount of media content such as, for example, music, video, image, and/or photography content. One example of a home entertainment electronic product is of the type provided by HEWLETT-PACKARD COMPANY under the product name “DIGITAL ENTERTAINMENT CENTER” (DEC). The DEC product is an Internet-connected stereo component that brings the Internet music experience to the household room of the consumer. With DEC, the consumer can perform various functions such as, for example, (1) store and automatically catalog up to approximately 750 compact disks (CDs) in the hard drive of the DEC, (2) create and enjoy multiple playlists of favorite tracks, (3) download music and/or purchase CDs, and/or (4) listen to Internet radio programs or the audio output from tracks that are stored in the DEC hard drive.

Since a home entertainment electronic device (such as the DEC) includes electrical and mechanical components, failure can occur in these types of devices. If a disk failure were to occur in the hard drive of these devices, then the consumer has the problem of losing a substantial amount of songs (or other media content) that are stored in the hard drive. Typically, this consumer has previously spent an extensive amount of time to acquire the songs and store the songs on the hard drive.

Currently, the data backup strategy for the DEC product (or other digital entertainment products) is for the customer to restore the original CD contents (or other music content or tracks) into the DEC hard drive, after a disk repair has been performed and completed on the DEC hard drive. However, this backup strategy has a two-fold problem. First, it takes a customer several days (or weeks) of effort to physically load and restore their music library on the DEC hard drive, particularly if the customer will require the reload several hundred (e.g., 700) CDs into the DEC. For example, it may require about 15 minutes to about 30 minutes (or longer) to load a CD into a CD drive of the DEC and copy the content of the loaded CD into the DEC hard drive. Second, there is no known existing method to recover songs that were purchased by the customer via the Internet from an online source and were digitally downloaded into the DEC hard drive, without requiring the customer to again pay in order to again download the songs from the Internet online source and into the DEC hard drive.

One possible method of a data backup strategy for a digital entertainment device (such as the DEC) is to perform a backup and data restore procedure via a third party service that can be connected to the digital entertainment device through the Internet. However, this method has proven to be impractical. For example, even with the use of Internet connections with broadband speeds, a data reload into the digital entertainment device hard drive will require several days or weeks for the customer to perform. This possible method may be viable for small-sized or medium-sized data requirements (e.g., a few hundred megabytes). However, this possible method will require an unacceptable amount of time (e.g., several days or weeks) for downloading larger-sized data (e.g., 40 gigabyte or more) into the entertainment device hard drive. For example, even if a customer has a high-speed connection (such as a Digital Subscriber Line or DSL) operating at 1 mbs, the restoration of a 35 GB disk on a digital entertainment device would take over three days at best. As the data storage capacity of a digital entertainment device increases and/or as the type of content size increases (e.g., content such as photos, video, or images), this conventional backup and data restore procedure via the Internet is likely to become more impractical.

Another possible method of a data backup strategy is for the customer to purchase a backup device (e.g., tape, disk or CD backup device) and to perform a local backup of the media content in the digital entertainment device hard drive to this backup device. However, this possible method is also less viable due to the fact that the customer would be requested to purchase an additional and not inexpensive device (e.g., several hundred dollars or more in cost) that would rarely be used. Furthermore, this backup device will typically require additional space in a household room because a digital entertainment device and its peer devices are typically already placed in a living room stereo rack. Additionally, by requesting a customer to purchase this backup device, the digital entertainment device vendor might be placed in a negative light by implicitly suggesting that a customer is required to purchase the backup device due to the potential unreliability of the digital entertainment products.

As a result, the current and known possible data backup strategies are insufficient and can lead to customer dissatisfaction for digital entertainment devices. For new types of digital entertainment products that are targeted to new markets, it is typically important to reduce the potential customer dissatisfaction with and critical review of the new product types, and it is desirable to obtain favorable review of the new product types by word-of-mouth, printed publications (e.g., newsletters, magazines, or newspapers), online chat-rooms (e.g., Internet chat-rooms), radio or television or on-line advertisements, and/or by other publication activities.

Therefore, the current technology is limited in its capabilities and suffers from at least the above constraints and deficiencies.

### SUMMARY OF EMBODIMENTS OF THE INVENTION

Embodiments of the invention relate generally to remote backup and restore techniques for various media content such as, for example, music content, video content, image or photography content, or other electronic content. These media content are typically stored in a memory (e.g., a hard drive or other type of memory) of a digital entertainment device or unit.

In one embodiment of the invention, a method for remote data backup and restoration includes creating a signature tag that is associated with a track stored in a memory of a digital entertainment unit, transmitting the signature tag to a repair facility, and authenticating the track based upon the signature tag. If the digital entertainment unit fails, then the digital entertainment unit is sent to the repair facility. After repair has been performed on the digital entertainment unit at the repair facility, the track can be restored on the memory if the track is authenticated. The digital entertainment unit can then be returned to the owner or customer.

In another embodiment of the invention, an apparatus for remote data backup and restoration includes a digital entertainment unit that is configured to create a signature tag that is associated with a track stored in a memory of the digital entertainment unit and to transmit the signature tag to a repair facility. The repair facility can then authenticate the track based upon the signature tag.

These and other features of an embodiment of the present invention will be readily apparent to persons of ordinary skill in the art upon reading the entirety of this disclosure, which includes the accompanying drawings and claims.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram of a system, in accordance with an embodiment of the invention.

FIG. 2 is a block diagram that shows additional details of the system of FIG. 1, in accordance with an embodiment of the invention.

FIG. 3 is a high level block diagram of a signature tag, in accordance with an embodiment of the invention.

FIG. 4 is a block diagram that shows additional details of a first part of the signature tag, in accordance with an embodiment of the invention.

FIG. 5 is a block diagram that shows additional details of a second part of the signature tag, in accordance with an embodiment of the invention.

FIG. 6 is a block diagram illustrating the content in a customer account folder, in accordance with an embodiment of the invention.

FIG. 7 is a flowchart illustrating a method of a remote backup and data restore, in accordance with an embodiment of the invention.

### DETAILED DESCRIPTION OF PREFERRED EMBODIMENTS

In the description herein, numerous specific details are provided, such as examples of components and/or methods, to provide a thorough understanding of embodiments of the invention. One skilled in the relevant art will recognize, however, that an embodiment of the invention can be practiced without one or more of the specific details, or with other apparatus, systems, methods, components, materials, parts, and/or the like. In other instances, well-known structures, materials, or operations are not shown or described in detail to avoid obscuring aspects of embodiments the invention.

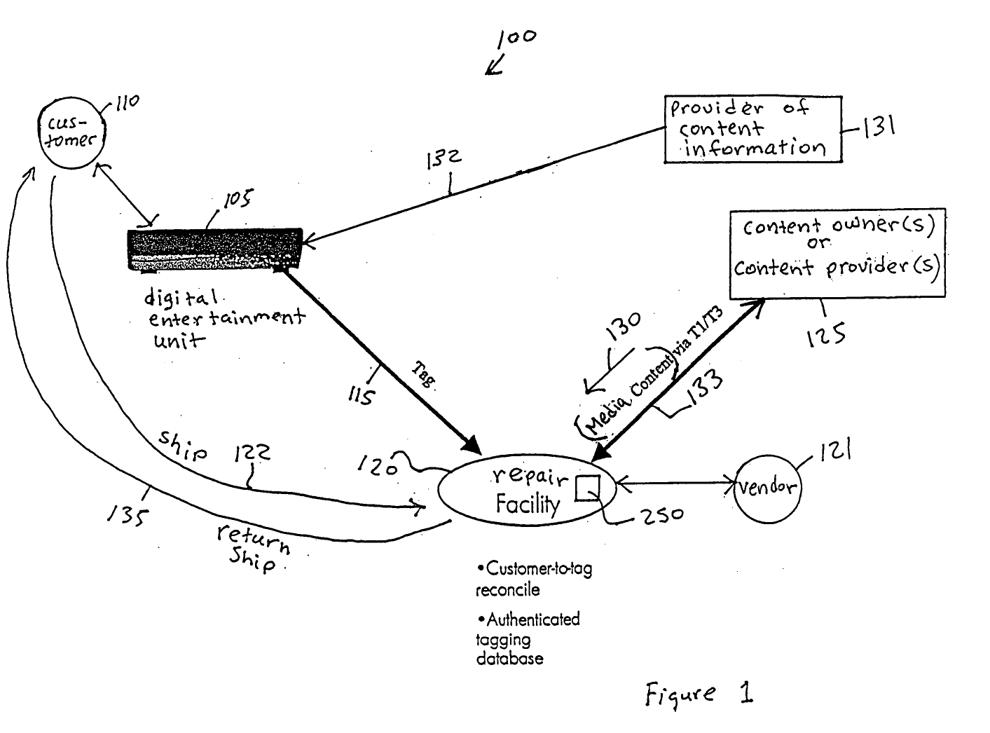

FIG. 1 is a block diagram of a system 100 that can implement an embodiment of the invention. The system 100 includes a digital entertainment unit (or digital entertainment device) 105 that has been legally obtained (e.g., purchased) by a customer 110. Previous types of DEUs include, for example, the DIGITAL ENTERTAINMENT CENTER (DEC) which is provided from Hewlett-Packard Company. The DEU 105 performs various functions such as, for example, (1) storing and automatically cataloging media content such as digital music content, (2) creating multiple playlists of favorite tracks, (3) downloading music and/or permitting the customer to purchase CDs, and/or (4) permitting the customer to listen to Internet radio programs or the audio output from tracks that are stored in a memory (e.g., a hard drive or other type of memory) of the DEU 105.

Typically, the DEU 105 is placed in, for example, the living room or other suitable household room (or other suitable locations) to provide entertainment functionality to the customer 110 and/or other individuals in the room or location. In one embodiment, the DEU 105 can store, for example, about 750 CDs tracks (or about 9,000 tracks) and provide the selected music or audio output for the listening pleasure of the customer 110. Of course, as memory technology advances, the DEU 105 may be able to store larger amounts of data.

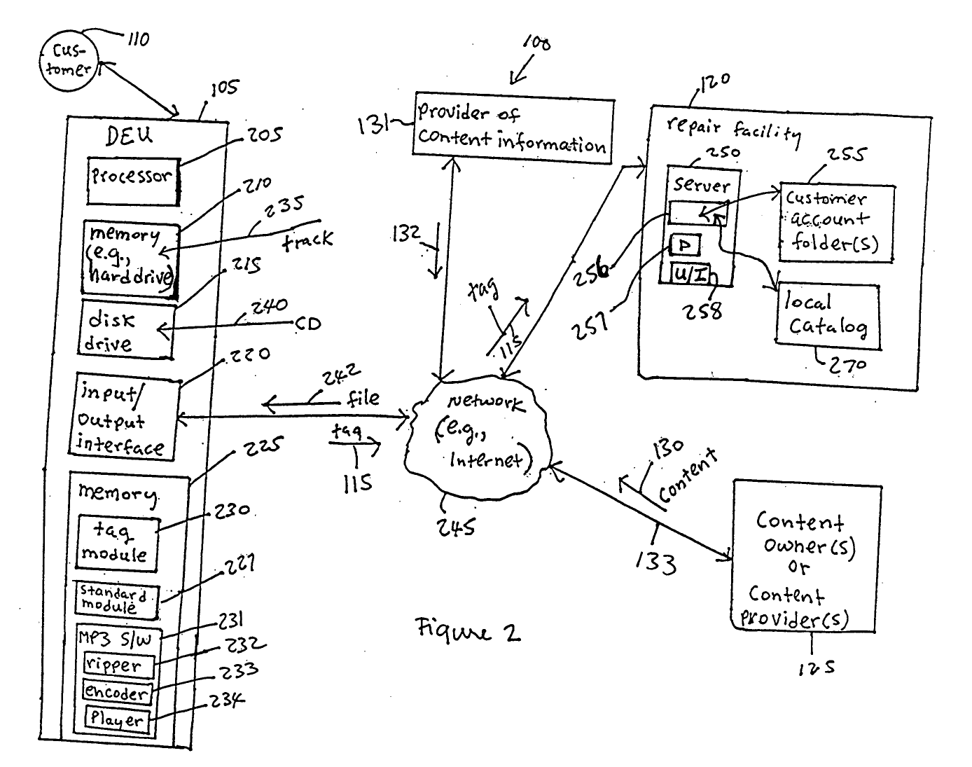

As discussed in further detail below, the DEU 105 can create and transmit a signature tag 115 to a repair facility 120. The signature tag 115 is associated to a particular media track 235 (see FIG. 2) that have been copied to a memory 210 (see FIG. 2) of the DEU 105. As an example, the memory 210 may be a hard drive or other type of memory. The track 235 can be, for example, a song track from an album or CD, from an online music source, or from other suitable media sources. However, as discussed below, the signature tag 115 may also be associated with tracks that are of other content types such as, for example, video content, image or photography content, or other electronic content that have been copied to the memory 210 of the DEU 105. The signature tag 115 permits the repair facility 120 to reconcile customers 110 with the signature tags 115 and to authenticate tracks and/or albums/CDs (or other media content) that have been legally obtained by the customer 110 and previously copied into the memory 210 of the DEU 105.

When the DEU 105 fails, the customer 110 can send (e.g., ship) 122 the DEU 105 to the repair facility 120 for repair. For example, the customer 110 can express ship at the expense of the vendor 121 (or manufacturer) of the DEU 105. Typically, the vendor 121 (or manufacturer) of the DEU 105 and the repair facility 120 can have an agreement for the process of receiving, repairing, and returning any DEUs 105 that fail and are repaired at the repair facility 120. Alternatively, the repair facility 120 may be an actual repair facility of the vendor 121 (or manufacturer) of the DEU 105. The repair facility 120 will typically have access to the parts, equipment, and/or personnel to repair a DEU 105 that has failed. As one example, the repair facility 120 may be under the management or ownership of Kyocera Corporation <www.kyocera.com>, although other entities may manage a repair facility 120.

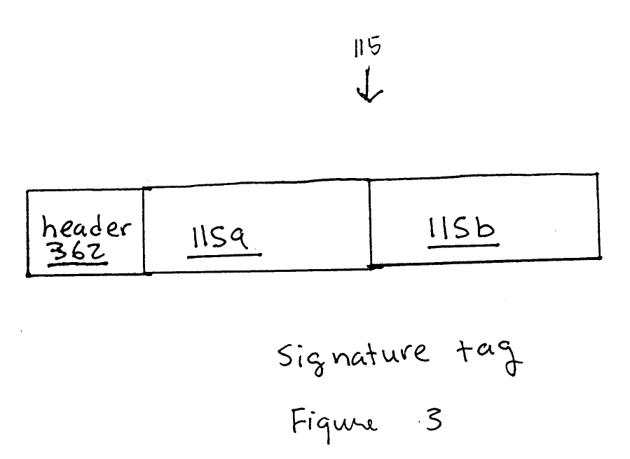

A provider 131 of content information provides content information 132 that allows an initial lookup capability (for the repair facility 120 personnel) about a media content such as a song. As discussed below, this content information 132 is used as a second part 115b (FIG. 3) of the tag 115. A first part 115a (FIG. 3) of the tag 115 is generated by the DEU 105 that is the origin device that stored the media content. The first part 115a and second part 115b of the tag 115 are used to authenticate the media content at the repair facility 120. One example of the content information provider (third party service) 131 is GRACENOTE CDDB <www.gracenote.com> which is a comprehensive music information database service, although other content information providers may be used.

A content owner(s) or content provider(s) 125 may provide replacement authenticated media content 130 to the repair facility 120 by use of a suitable communication line 133 such as a T1 or T3 line (or other suitable communication line) from the facility of the owner/provider 125 to the repair facility 120. Alternatively or additionally, the replacement authenticated media content 130 may be obtained from one or more servers 250 that are located at the repair facility 120. The servers 250 would store an entire catalog of media content (e.g., songs) that have been licensed from the content owners 125. Use of these servers 250 can provide a much faster media content restoration speed at the repair facility 120 than the above-mentioned restoration method that uses the T1/T3 line to obtain the media content 130.

As an example, the owner/provider 125 may be a known media content provider. For example, if the media content 130 is music, then the content owners may be the traditional music labels commonly known as the “Big Five” which now is formed by EMI RECORDS, BMG (music division of BERTELSMANN AG) TIME-WARNER, SONY, and VIVENDI UNIVERSAL. The media content provider/provider 125 may also be other sources of media such as, for example, the Library of Congress <www.loc.gov> or other suitable media sources. The content owner/provider 125, in the above example, can then provide the replacement media content 130 in the form of audio or song tracks in this particular example.

As mentioned above, the replacement media content 130 is available to the repair facility 120 for restoration of the previously stored media content (e.g., track 235) on the memory 210 of the DEU 105, when the repair facility 120 has repaired the failing DEU 105 and has authenticated the media content (track 235) stored in the failing DEU 105. For media content that are authenticated (and therefore are media content that are determined to be legally owned or previously-purchased by the customer 110), the repair facility 120 can then load the appropriate replacement media content 130 into the memory 210 of the repaired DEU 105. The repair facility 120 can then return 135 (e.g., return by shipping) the repaired and data restored DEU 105 to the customer 110. As a result of this repair of the failing DEU 105 and data restoration process, the customer 110 is made whole again.

FIG. 2 is a block diagram that shows additional details of the system 100 of FIG. 1, in accordance with an embodiment of the invention. The DEU 105 includes a processor 205 for executing various software in the DEU 105, a memory 210 for storing media content (such as, for example, digital music content), a disk drive 215 for loading a memory disk (e.g., CD 240) with media content, and an input/output interface 220 that permits connectivity to a network 245 such as, for example, the Internet.

The memory 210 may be, for example, a hard drive or other type of memory. In the discussion below, the memory 210 may be specifically referred to as a hard drive 210, for purposes of explaining the functionalities of an embodiment(s) of the invention. However, the memory 210 may be another suitable type of memory. Additionally, in another embodiment of the invention, the memory 210 and memory 225 may be implemented as a single memory device.

In the discussion below, the network 245 may be specifically referred to as the Internet 245, for purposes of explaining the functionalities of an embodiment(s) of the invention. However, the network 245 may be another suitable type of data communication network such as, for example, a locally provided and maintained wide area data communication network or other types of communication networks. The Internet connection can be made via DSL, dial-up modem, or other suitable connections by using one of the I/O ports of the I/O interface 220. The input/output interface 220 also typically includes a user interface that permits the customer 110 to input commands into the DEU 105 and to receive audio and/or video and/or image output.

In an embodiment, the DEU 105 also includes a memory 225 such as, for example, an electrically erasable programmable read-only memory (EEPROM) which is user-modifiable read-only memory (ROM) that can be erased and reprogrammed (written to) repeatedly through the application of higher than normal electrical voltage. The memory 225 can store a standard module 227 which may include standard software and/or firmware (such as a LINUX operating system in an implementation of the DEC product) to permit the DEU 105 to perform various intended functions.

The memory 225 can also store a tag module 230 which can gather attributes information of music tracks, assigned unique file names for each track 235 that is copied into the hard drive 210, customer information, DEU information, and/or other information as discussed below. Based upon the gathered attributes information, the tag module 230 can generate a tag 115 which is typically a data packet. The components of an example tag 115 are discussed below. The tag module 230 permits the processor 205 to process and transmit the tag 115 via network 245 to the server 250 in the repair facility 120. The tag 115 is then used in the repair facility 120 for authentication of customer-obtained media content (track(s) 235) that will be restored on a DEU 105 that has been repaired, as discussed below. The tag module 230 may be written in, for example, JAVA or other suitable languages that can be executed by a suitable operating system such as LINUX.

A track 235 may be, for example, a copy of a track from a CD 240 that is loaded into the disk drive 215 or may be a music file 242 that is downloaded from the Internet 245. The track 235 may also be other types of media content. It is noted that while the examples described herein are directed to storing and restoring media content such as music tracks, embodiments of the invention also apply to the storing and restoring of other types of media content such as, for example, video content, image content, movie content, and/or photography content.

Typically, the DEU 105 also includes an MP3 package (or software) 231 that processes audio files in the MP3 format. The MP3 module 231 is typically stored in memory (e.g., memory 225) and typically includes a ripper 232, encoder 233, and MP3 player 234. The MP3 module 231 is used to store a track 235 into the memory 210 in the specific example where the track 235 includes music content. In digital audio technology, the ripper 232 is a program that obtains a sound selection or sequence from a compact disk and copies the sound selection to a computer hard drive as a Wave file. A Wave file is a highly-compressed sound file that preserves the quality of a CD recording. The encoder 233 is a program that converts the Wave file into an MP3 file. The player 234 is a program that plays the MP3 file in order to generate an audio output.

It is noted that the MP3 format is just one example data format that could be used for a media track 235 that is copied to the memory 210 of the DEU 105, in accordance with an embodiment of the invention. Other suitable data formats could be used for audio, video, and image content in a media track 235. For example, suitable data formats for a media track 235 include, but are not limited to, the various data formats that are provided from the following vendors: MICROSOFT CORPORATION (e.g., WINDOWS MEDIA AUDIO and WINDOWS MEDIA VIDEO); REALNETWORKS, INC. (e.g., ra and rm files); and other vendors or industry groups.

Various known components and modules that permit a customer 110 to use the DEU 105 are not shown in FIG. 2 for purposes of describing a functionality of embodiments of the invention.

FIG. 3 is a high level block diagram of a signature tag 115, in accordance with an embodiment of the invention. The tag module 230 (FIG. 2) creates a signature tag 115 for each track 235 that is copied to the hard drive 210, whether the track 235 is from a CD 240 loaded in the disk drive 215, or copied through a home network from a PC (not shown in FIG. 2), or is digitally downloaded from the network 245 (e.g., the Internet) directly to the hard drive 210, or is legally obtained from other sources. Therefore, each track 235 that is loaded into the hard drive 210 is associated with its own unique signature tag 115.

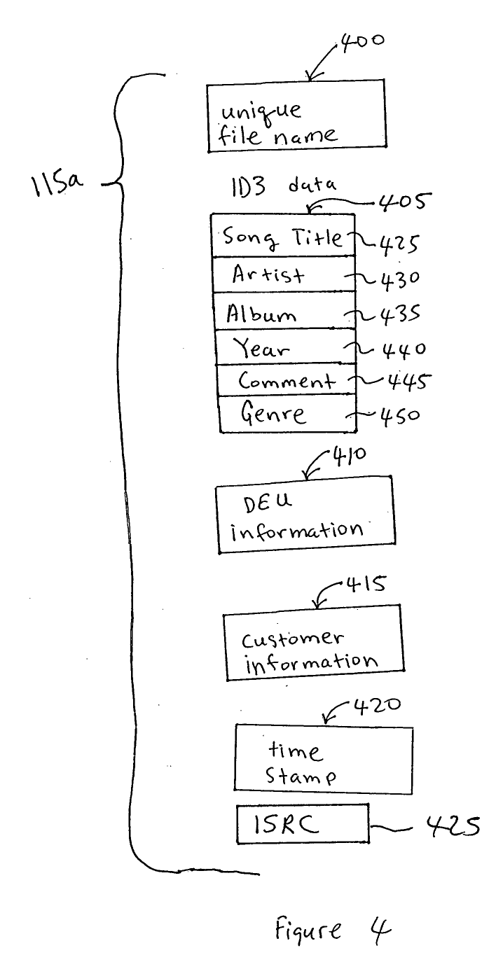

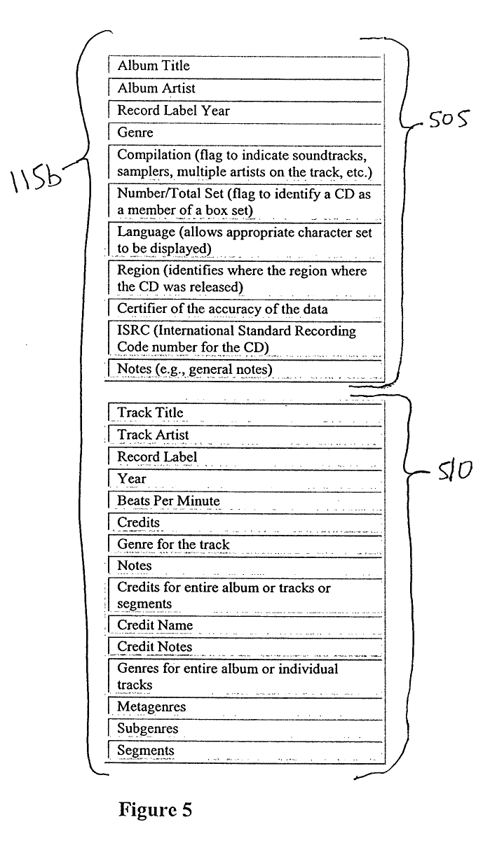

The tag module 230 creates the tag 115 by gathering data associated with first part 115a and second part 115b. The data that forms first part 115a and second part 115b are discussed below in additional detail in FIG. 4 and FIG. 5, respectively. It is within the scope of embodiments of the invention to use a signature tag 115 with other suitable formats. Therefore, the signature tag 115 is not limited to the example format that is shown in FIG. 3.

Each signature tag 115 is typically a DRM (digital rights management) acceptable “signature tag” that can be utilized for data backup and data restoration, in accordance with an embodiment of the invention. The customer 110 and the DEU vendor 121 can utilize the signature tags 115 to provide a legal accounting and authentication to the proper ownership of legally obtained music or other media content, as described below.

The size of a signature tag 115 is, for example, typically a few hundred bytes of data. The tag module 230 will format the signature tag 115 in data packet format by use of, for example, standard packet processing techniques.

In an embodiment of the invention, the processor 205 (FIG. 1) will execute the tag module 230 so that the tag module can create a signature tag 115 for each track 235 that is loaded in the hard drive 210 of the DEU 105. The signature tag 115 also includes a header 362 which has a destination address for the signature tag 115. For example, the destination address of the signature tag 115 is the address of the server 250 (FIG. 2) which will receive and store the signature tag 115 into an appropriate customer account folder 255 that has been associated with the customer 110.

The data backup and restoration process would work automatically and transparently to the customer 110. Every time that a particular track 235 is stored in the hard drive 210, the tag module 230 creates a signature tag 115 that is associated with that loaded particular track 235. The tag module 230 then forwards the signature tag 115 to a server 250 (FIG. 2) which is typically within or managed by the repair facility 120. The server 250 maintains one or more account folders 255 that are assigned to each customer 110 who has legally obtained a DEU 105. Typically, after a new customer 110 had registered a DEU 105, the repair facility 120 will create an account folder 255 in the server 250 for that new customer 110. When a signature tag 115 is received by the server 250, the signature tag 115 is logged or copied into an account folder 255 of the customer 110 who is associated with the signature tag 115. Typically, the customer account folders 255 are stored in a memory 256 that is associated with the server 250.

As discussed above, the signature tag 115, which is a small data element, is sent via the network 245 to the server 250. Therefore, the entire track 235 itself is not sent via the network 245 to the server 250. By transmitting the signature tags 115, even the slowest dial-up modems advantageously have plenty of bandwidth to cover the backup requirements for tracks 235 that are loaded into the hard drive 210. If a failure of the hard drive 210 were to occur, the customer 110 will express ship his/her failing DEU 105 to the repair facility 120, as a customer would ordinarily perform in any situation requiring a service to a failing physical device.

The information in the signature tag 115 permits the personnel of the repair facility 120 to authenticate and determine which tracks 235 have been legally obtained by a customer who owns the failing DEU 105. Standard packet processing techniques may be executed by the server 250 processor 257 and firmware/software in order to read the information in each of the signature tags 115 in the customer account folder 255. The repair facility personnel can view the information in each of the signature tags 115 via, for example, a user-interface 258 in the server 250.

The tracks 235 that are authenticated can then be restored by the repair facility 120 into the hard drive 210 of the DEU 105 after device repair and testing have been completed. Therefore, after the physical repair is completed for the DEU 110 in the repair facility 120, a logical repair (data restoration) is performed as well. The logical repair involves a true full restoration of the customer's original content of media tracks 235 in the hard drive 210, for all tracks 235 that are authenticated by use of the signature tag 115.

There are at least two possible approaches for performing the restoration of tracks 235 into the hard drive 210 of the repaired DEU 105. In one approach, a high-speed Internet connection 133, such as a T1 or T3 service, connects the repair facility 120 to the content owners or content providers 125. The customer's account folder 255 is used to determine the specific legal re-loadable tracks 235 from the owner(s)/provider(s) 125.

The repair facility 120 may have an agreement with the provider(s)/owner(s) 125, where the provider(s)/owner(s) 125 provides the content 130 to the repair facility 120. The repair facility 120 can then perform the content restoration, after the repair facility 120 is able to determine/authenticate the particular tracks 235 that are legally obtained by the customer 110.

In a second approach, the repair facility 120 maintains a local catalog 270 of tracks 235 and utilizes the customer's account records in the account folders 255 to determine which tracks 235 in the local catalog 270 are to be properly re-loaded/restored into the hard drive 210 of the repaired DEU 105. The local catalog 270 of tracks have been usually licensed (or purchased in some cases) from the appropriate content providers/owners 125. This approach would permit a faster turn-around time to the customer 110 for the repair and restoration process.

After the physical repair and logical repair has been completed on the DEU 105, the repair facility 120 can return (e.g., express ship) the repaired DEU 105 (with restored tracks 235) to the customer 110.

FIG. 4 is a block diagram that shows additional details of the first part 115a of the signature tag 115, in accordance with an embodiment of the invention. As mentioned above, the first part 115a is formed by information that is gathered by or is generated by the DEU 105. The first part 115a is used for authenticating the previously stored track 235 in the DEU 105 at the repair facility 120 prior to the restoration of the track 235 into the hard drive 210 after repair is performed on the DEU 105.

Assume, for example, that a track 235 is associated with a signature tag 115, and that the track 235 is a song track. In this example, the first part 115a of the signature tag 115 of the song track will typically include the following data as discussed below. In this embodiment, the first part 115a will include a unique file name 400, ID3 data 405, DEU information 410, customer information 415, and optional time stamp 420, as discussed below in additional detail.

The tag module 230 incorporates a known file-naming capability that creates unique file names 400 that is associated with each track 235 that is stored in the hard drive 210. This file-naming capability is currently available in, for example, the above-mentioned DEC product from HEWLETT-PACKARD COMPANY. A unique file name 400 is assigned to each different track 235 that is copied to the hard drive 210 (FIG. 2) and is typically an encrypted data in digital format. Therefore, as an example, if five-hundred tracks 235 are stored into the hard drive 210, then the tag module 230 (FIG. 2) will create five-hundred unique file names 400, with a different unique file name 400 associated with each track 235. Each unique file name 400 is associated with a particular track 235, and the unique file names 400 are stored in, for example, an area of memory 225 (FIG. 2) and/or in the hard drive 210.

The MP3 software 231 stores a track 235 as an MP3 audio data file into hard drive 210, and an ID3 data chunk is included in the stored MP3 file. The ID3 data chunk for a track 235 is obtained from, for example, the track identification information in the CD 240. The ID3 data 405 is collected by the tag module 230 from the ID3 data chunk that is included with the MP3 audio data file that is stored in the hard drive 210. The ID3 standard is used in the music industry for cataloging many of the attributes of a music file. The ID3 format is a data chunk that is embedded in MPEG Layer I, Layer II and Layer III (MP3) files. The ID3 format is further described in, for example, the publication entitled “ID3 made easy” at the address link <http://www.id3.org/id3v1.html>.

Typically, the ID3 data 405 in the first part 115a of the signature tag 115 may include information about the song title 425, artist 430, album name 435, album year 440, comment 445 which is a comment field, and genre identification 450 for an associated track 235. The ID3 data 405 is typically the information obtained by the tag module 230 from an ID3v1 tag that is associated with the particular audio data of a track 235.

However, if the ID3 data is obtained from an ID3v1.1 tag, then the ID3 data 405 may also typically include the album track information for the audio data.

The DEU information 410 typically includes, for example, information that relates to the particular DEU 105 such as the serial number of the DEU 105, the model number of the DEU 105, and/or warranty information.

The customer information 415 typically includes, for example, information relating to the customer 110 such as the customer name and/or customer contact information such as the phone number and/or address of the customer 110. The customer information 415 is typically provided by the customer 110 during the product registration process.

The optional time stamp 420 typically indicates, for example, the time and day during which the associated particular track 235 was loaded into the hard drive 210. Therefore, each loaded track 235 may have an associated optional time stamp 420.

Recent or newer types of copy-protected and legally obtained CDs 240 will typically include an original authentication identifier that is provided by the CD manufacturer. This authentication identifier is typically the ISRC (International Standard Recording Code) code 425 which is included in the subcode of each track or recording and helps to ensure royalty payments. This original authentication identifier is typically used to create an associated unique file name 400 for each track 235 that is copied to the hard drive 210. Therefore, the repair facility 120 can check for these authentication identifiers in the unique file names 400 that are included in the signature tags 115. Alternatively, the ISRC code 425 may be included by the tag module 230 into the first part 115a of the signature tag 115.

It is noted that older types of CDs may not have the ISRC code 425. Therefore, in this case, the tag module 230 will create the unique file name 400 without the ISRC code 425.

An illegally obtained track will not have this original authentication identifier in the ISRC code 425 and will not, therefore, be included in a signature tag 115 (FIG. 3) that is associated with the illegally obtained track. Therefore, the repair facility 120 can refuse to restore the illegally-obtained track (and other tracks) on a hard drive 210 of a repaired DEU 105, unless the customer 110 can separately prove to the personnel of the repair facility 120 that the track 235 was actually legally obtained.

Legally obtained music files from an online source may also include authentication identifiers that are used to create the associated unique file names 400. Therefore, the repair facility 120 can check for these authentication identifiers in the unique file names 400 that are included in the signature tags 115, or check for separate authentication identifiers in the signature tag 115 itself.

For tracks 235 that contain DVD, movie, or video content, there are encrypted identifiers in these tracks to prevent piracy. These encrypted identifiers can be added to the signature tag 115 by the tag module 230, and the repair facility 120 can detect for these encrypted identifiers in the signature tag 115 to authenticate these types of media content. Similarly, tracks 235 that contain images or photos can have watermarks to prevent piracy. The watermark is an invisible pattern on a location of the image or photo. These watermarks can be added to the signature tag 115 by the tag module 230, and the repair facility 120 can detect for these watermarks in the signature tag 115 to authenticate these types of media content.

FIG. 5 is a block diagram that shows additional details of a second part 115b of the signature tag 115, in accordance with an embodiment of the invention. As mentioned above, the second part 115b is formed by the content information 132 obtained from third-party provider 131. The second part 115b is used for authenticating the previously stored track 235 in the DEU 105 at the repair facility 120 prior to the restoration of the track into the hard drive 210 after repair is performed on the DEU 105.

The second part 115b of the signature tag 115 includes the media content information 132 that is obtained from the third party provider 131 (FIG. 1). Assuming that a track 235 is associated with a signature tag 115 is a song track, then the second part 115b of the signature tag 115 will typically include music content information that can be obtained from a suitable third party provider 131 such as, for example GRACENOTES CDDB. In this example, the second part 115b will include album data fields 505 which have information on the album that includes the track 235, and track data fields 510 which have information about the track 235. In the example of FIG. 5, the album data fields 505 may include at least some of the following information: album title, album artist, record label year, genre, compilation (a flag to indicate soundtracks, samplers, multiple artists, etc.), number/total-set (a flag to identify a CD as a member of a box set), language, regions, certifier of the accuracy of the audio data, ISRC code, and/or notes (e.g., general notes). The information in the album data fields 505 may be varied, increased, or decreased.

In the example of FIG. 5, the track data fields 510 may include at least some of the following information: track title, track artist, record label, year, beats per minute, credits, genre for the track, notes, credits for entire album or tracks or segments, credit name, credit notes, genres for the entire album or individual tracks, metagenres, subgenres, and/or segments. The information in the track data fields 510 may be varied, increased, or decreased.

Each time that a track 235 is copied to the hard drive 210, the DEU 105 connects via network 245 (e.g., Internet) 245 to the third party service provider 131 that provides content information 132. The tag module 230 then obtains the content information 132 for each particular track 235 from the third party service provider 131, after the particular track 235 is copied to the hard drive 210. The appropriate content information 132 for a track 235 is determined by the service provider 131 based upon track identification information provided by the tag module 230 to the service provider 131. For example, the track identification information may be the ID3 data 405 of the track 235. The content information 132 (from the service provider 131) is then included by the tag module 230 as the second part 115b of the signature tag 115. This known operation of obtaining the content information 132 from the third party service provider 131 for each track 235 that is copied on the hard drive 210 is currently a feature in, for example, the DEC product. The tracks 235 can be copied in groups into the hard drive 210 and then the associated content information 132 for each track 235 are fetched online in groups via network 245. The content information 132 can be sent individually or as a queue in a group by the third party service provider 131 to the DEU 105. The content information 132 may also be locally pre-stored in the DEU 105 memory (e.g., hard drive 235), so that the content information 132 does not have to be fetched online. This pre-stored content information 132 may then be periodically updated by use of, for example, firmware.

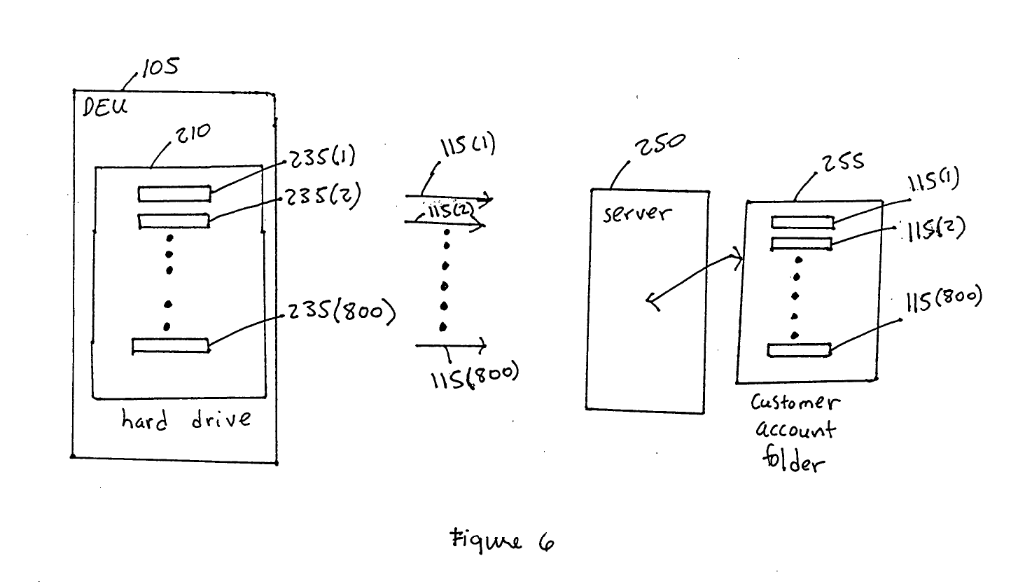

FIG. 6 is a block diagram illustrating the content in a customer account folder 255, in accordance with an embodiment of the invention. Assume that eight-hundred tracks were loaded by the customer 110 into the hard drive 210 of the DEU 105. In this example, tracks 235(1) to 235(800) have been loaded into the hard drive 210. As a result of loading the tracks 235 into the hard drive 210, the signature tags 115(1) to 115(800) are created by the tag module 230 (FIG. 2) and are transmitted to the server 250. The signature tags 115(1) to 115(800) are then stored in a particular customer account folder 255 that has been assigned by the repair facility 120 to the customer 110. The signature tags 115(1) to 115(800) will include information that identifies the particular customer 110 who is associated with the signature tags 115(1) to 115(800). Other customers 110 will have their own assigned customer account folder 255. Each signature tag 115(1) to 115(800) is associated with and includes information about one of the tracks 235(1) to 235(800). For example, the signature tag 115(1) includes information about the track 235(1) that is stored in the hard drive 210, while the signature tag 115(2) includes information about the track 235(2).

The personnel in the repair facility 120 can determine the tracks 235(1) to 235(800) that have been previously loaded into the hard drive 210 based upon the signature tags 115 that are stored in the customer account folder 255. After the DEU 105 has been shipped to the repair facility 120 and has been repaired, the repair facility 120 can authenticate the previously stored tracks 235(1) to 235(800) by examining the signature tags 115(1) to 115(800) in the customer account folder 255. The authenticated tracks, also generally referred to as tracks 235, are then re-stored into the hard drive 210 of the repaired DEU 105. As mentioned above, the personnel in the repair facility 120 can obtain the authenticated tracks 235 from the content owner/provider 125 via a data communication line 133, or from a local catalog 270 (FIG. 2), if available. After the authenticated tracks 235 have been re-loaded in the hard drive 210, the DEU 105 can then be returned to the customer 110.

Therefore, the use of the signature tags 115 permits a vendor of the DEU 105 to take an important additional step to authenticate media content that have been previously obtained by a customer 110, and prevent media content piracy. At the same time, the signature tags 115 permit the restoration of the legally obtained media content to the hard drive 210 of a DEU 105 that has been repaired after device failure occurrence, where restoration is performed in an efficient and expedient manner.

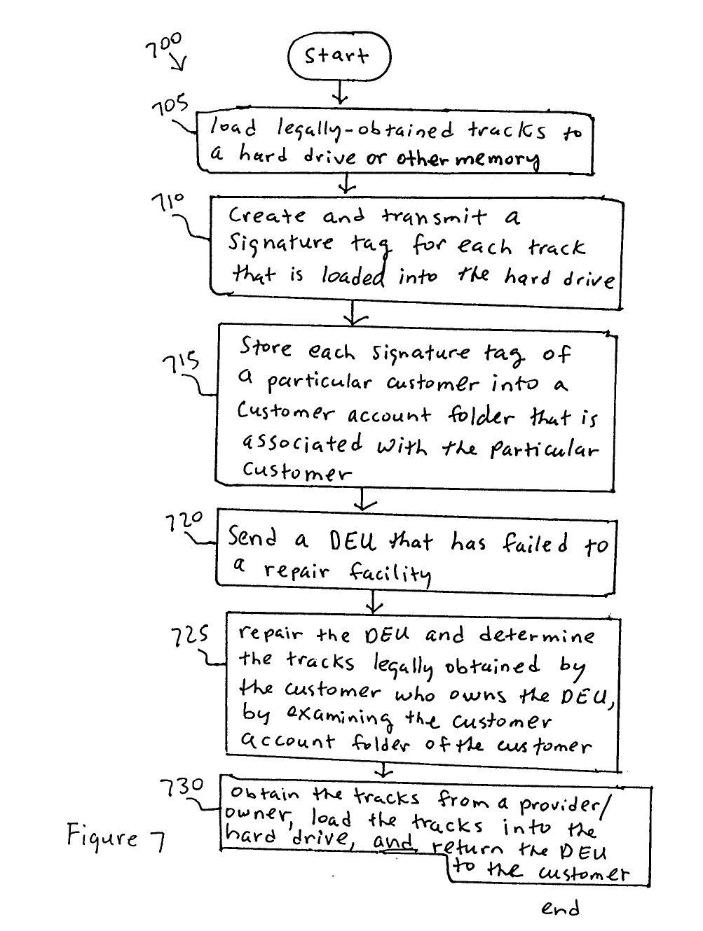

FIG. 7 is a flowchart illustrating a method 700 of a remote backup and data restore, in accordance with an embodiment of the invention. The customer first loads (705) one or more legally-obtained tracks to a hard drive (or other type of memory) of a digital entertainment unit (DEU). For each track that is loaded into the hard drive, a signature tag is created and transmitted (710) to a server 250 that is managed by a repair facility. Each signature tag of a particular customer is stored (715) into a customer account folder that is associated with the particular customer.

The customer would send (720) a DEU (that has failed) to the repair facility. In step 725, the DEU is repaired at the repair facility, and a determination is made on which tracks were legally obtained by the customer who owns the DEU, by examining the signature tags in the customer account folder of the customer. Therefore, the examination of a signature tag permits the authentication of the associated track.

In step 730, the authenticated tracks are obtained from a content provider/owner (or from a catalog in a server in the repair facility) and loaded into the hard drive of the DEU of the customer if the tracks were previously legally obtained by the customer, and the DEU is then returned to the customer.

Various advantages are possible with embodiments of the invention. First, an embodiment of the invention provides a repair and restoration process that reduces expenses for the customer 110 and the vendor 121 of the digital entertainment unit 105. The process is a relatively seamless and transparent process to the customer 110. The process also provides a more elegant restoration technique because the customer 110 is not forced to purchase another device for data backup. As a result, the customer 110 does not incur additional expenses and does not face the problem of maintaining a backup device that occupies household space and that would be rarely used. Additionally, the process eliminates the prior technique of performing a complete data backup and restoration by use of the Internet which is limited for much smaller data transfers.

Additionally, embodiments of the invention safeguard the customer 110 from losing his/her significant investment in media content, such as music content. The customer 110 is provided with a near-effortless method of restoring his/her music content in the event of a disk failure on the digital entertainment unit 105. As a result, the customer 110 does not lose his/her investment in media content in the event of a disk failure and is made whole again after disk repair and content restoration.

Additionally, embodiments of the invention permit the practice of Digital Rights Management (DRM) in the handling and management of music content. As a result, embodiments of the invention encourage the possibility of deeper and stronger relationships between the digital entertainment unit vendor 121 and the music content owners and/or music content providers 125.

The various engines or codes discussed herein may be, for example, software, firmware, commands, data files, programs, modules, instructions, or the like, and may also include suitable mechanisms.

Reference throughout this specification to “one embodiment”, “an embodiment”, or “a specific embodiment” means that a particular feature, structure, or characteristic described in connection with the embodiment is included in at least one embodiment of the present invention. Thus, the appearances of the phrases “in one embodiment”, “in an embodiment”, or “in a specific embodiment” in various places throughout this specification are not necessarily all referring to the same embodiment. Furthermore, the particular features, structures, or characteristics may be combined in any suitable manner in one or more embodiments.

Other variations and modifications of the above-described embodiments and methods are possible in light of the foregoing teaching.

Further, at least some of the components of an embodiment of the invention may be implemented by using a programmed general purpose digital computer, by using application specific integrated circuits, programmable logic devices, or field programmable gate arrays, or by using a network of interconnected components and circuits. Connections may be wired, wireless, by modem, and the like.

It will also be appreciated that one or more of the elements depicted in the drawings/figures can also be implemented in a more separated or integrated manner, or even removed or rendered as inoperable in certain cases, as is useful in accordance with a particular application.

It is also within the scope of the present invention to implement a program or code that can be stored in a machine-readable medium to permit a computer to perform any of the methods described above.

Additionally, the signal arrows in the drawings/Figures are considered as exemplary and are not limiting, unless otherwise specifically noted. Furthermore, the term “or” as used in this disclosure is generally intended to mean “and/or” unless otherwise indicated. Combinations of components or actions will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

1. A method for remote data backup and restoration, the method comprising:
creating a signature tag that is associated with a track stored in a memory of a digital entertainment unit;
transmitting the signature tag to a repair facility; and
authenticating the track based upon the signature tag.

2. The method of claim 1, wherein the track includes media content.

3. The method of claim 1, wherein the signature tag comprises:
a first part including information about the customer, digital entertainment unit, and source of the track.

4. The method of claim 3, wherein the first part of the signature tag comprises at least one of a unique file name, ID3 data, information related to the digital entertainment unit, customer information, and authentication identifier.

5. The method of claim 4, wherein the ID3 data is obtained from a stored MP3 file that includes the track.

6. The method of claim 1, wherein the signature tag comprises:
a second part including content information about the track.

7. The method of claim 6, wherein the content information is obtained from a third party service.

8. The method of claim 6, wherein the content information comprises album data and track data.

9. The method of claim 1, wherein the signature tag comprises:
a header including a destination address for the signature tag.

10. The method of claim 1, further comprising:
storing the signature tag at a server in the repair facility.

11. The method of claim 10, wherein the signature tag is stored in a customer account folder in the server, and wherein the customer account folder is associated with an owner of the digital entertainment unit.

12. The method of claim 1, further comprising:
sending the digital entertainment unit to the repair facility if the digital entertainment unit is subject to failure.

13. The method of claim 1, further comprising:
if the track has been authenticated, then restoring the track into the memory of the digital entertainment unit after repairing the digital entertainment unit.

14. The method of claim 13, wherein the authenticated track is obtained from a content owner by use of a communication line from a facility of the content owner to the repair facility.

15. The method of claim 13, wherein the authenticated track is obtained from a server in the repair facility.

16. An apparatus for remote data backup and restoration, the apparatus comprising:
a digital entertainment unit configured to create a signature tag that is associated with a track stored in the digital entertainment unit, and to transmit the signature tag to a repair facility.

17. The apparatus of claim 16, wherein the digital entertainment unit further comprises:
a processor;
a memory; and
a tag module that is executable by the processor, wherein the tag module is configured to create the signature tag that is associated with the track stored in the memory and to transmit the signature tag to a repair facility.

18. The apparatus of claim 16, wherein the track is authenticated at the repair facility based upon the signature tag.

19. The apparatus of claim 16, wherein the track includes media content.

20. The apparatus of claim 16, wherein the signature tag comprises:
a first part including information about the customer, digital entertainment unit, and source of the track.

21. The apparatus of claim 20, wherein the first part of the signature tag comprises at least one of a unique file name, ID3 data, information related to the digital entertainment unit, customer information, and authentication identifier.

22. The apparatus of claim 21, wherein the ID3 data is obtained from a stored MP3 file that includes the track.

23. The apparatus of claim 16, wherein the signature tag comprises:
a second part including content information about the track.

24. The apparatus of claim 23, wherein the content information is obtained from a third party service.

25. The apparatus of claim 23, wherein the content information comprises album data and track data.

26. The apparatus of claim 16, wherein the signature tag comprises:
a header including a destination address for the signature tag.

27. The apparatus of claim 16, wherein the signature tag is stored at a server in the repair facility.

28. The apparatus of claim 27, wherein the signature tag is stored in a customer account folder in the server, and wherein the customer account folder is associated with an owner of the digital entertainment unit.

29. The apparatus of claim 16, wherein the digital entertainment unit is sent to the repair facility if the digital entertainment unit is subject to failure.

30. The apparatus of claim 16, wherein if the track has been authenticated, then the track is restored into the memory of the digital entertainment unit after repairing the digital entertainment unit.

31. The apparatus of claim 30, wherein the authenticated track is obtained from a content owner by use of a communication line from a facility of the content owner to the repair facility.

32. The apparatus of claim 30, wherein the authenticated track is obtained from a server in the repair facility.

33. An apparatus for remote data backup and restoration comprising:
means for creating a signature tag that is associated with a track stored in a memory, and for transmitting the signature tag to a repair facility.

34. An article of manufacture, comprising:
a machine-readable medium having stored thereon instructions to:
create a signature tag that is associated with a track stored in a memory of a digital entertainment unit; and
transmit the signature tag to a repair facility.

35. A method for remote data backup and restoration, the method comprising:
creating a signature tag for a track that is loaded by a customer into a memory of a digital entertainment unit (DEU);
transmitting the signature tag to a repair facility and storing the signature tag into an account folder that is associated with the customer;
sending the DEU that has failed to the repair facility;
repairing the DEU, and determining the tracks legally obtained by the customer by examining the signature tags in the customer account folder;
loading the tracks into the memory of the DEU; and
returning the DEU to the customer.

36. A method for authenticating media content, the method comprising:
receiving a signature tag that is associated with a track stored in a memory of a digital entertainment unit; and
authenticating the track based upon the signature tag.

37. The method of claim 36, wherein the track includes media content.

38. The method of claim 36, wherein the signature tag comprises:
a first part including information about the customer, digital entertainment unit, and source of the track.

39. The method of claim 36, wherein the signature tag comprises:
a second part including content information about the track.

40. The method of claim 36, wherein the signature tag comprises:
a header including a destination address for receiving the signature tag.

41. The method of claim 36, wherein the signature tag is stored in an account folder.

42. An apparatus for authenticating media content, the apparatus comprising:
a server configured to receive a signature tag that is associated with a track stored in a memory of a digital entertainment unit, and to permit authentication of the track based upon the signature tag.

43. The apparatus of claim 42, wherein the track includes media content.

44. The apparatus of claim 42, wherein the signature tag comprises:
a first part including information about the customer, digital entertainment unit, and source of the track.

45. The apparatus of claim 42, wherein the signature tag comprises:
a second part including content information about the track.

46. The apparatus of claim 42, wherein the signature tag comprises:
a header including a destination address of the server for receiving the signature tag.

47. The apparatus of claim 42, wherein the signature tag is stored in an account folder.

48. A method for remote data backup and restoration, the method comprising:
creating a signature tag that is associated with a track stored in a memory of a digital entertainment unit; and
transmitting the signature tag to a destination for storage.

49. The method of claim 48, further comprising:
authenticating the track based upon the signature tag.
